(19) United States
(12) Patent Application Publication
(10) Pub. No.: US 2014/0248501 A1
(43) Pub. Date: Sep. 4, 2014

(54) POLYETHER POLYOL RESINS COMPOSITIONS

(71) Applicant: Momentive Speciality Chemicals Inc., Columbus, OH (US)

(72) Inventors: Denis Heymans, Ottignies-Louvain-la-Neuve (BE); Christophe Steinberger, Ottignies-Louvain-la-Neuve (BE); Cédric Le Fevere De Ten Hove, Ottignies-Louvain-la Neuve (BE)

(21) Appl. No.: 14/352,272

(22) PCT Filed: Oct. 16, 2012
(86) PCT No.: PCT/EP2012/004323

§ 371 Date: Apr. 16, 2014

(30) Foreign Application Priority Data
Oct. 19, 2011 (EP) 11075229.2
Apr. 6, 2012 (EP) 12002486.4

(51) Int. Cl. C08G 65/26

(52) U.S. Cl. CPC C08G 65/2609
USPC 428/457; 528/361; 428/411.1

(57) ABSTRACT

The invention relates to compositions of polyether polyol resins (hydroxyfunctional oligo or poly ether) comprising a mixture of α,α-branched alkane carboxylic glycidyl esters derived from butene oligomers characterized in that the sum of the concentration of the blocked and of the highly branched isomers is at least 50%, preferably above 60% and most preferably above 75% on total composition.

The present invention relates to a composition of polyether polyol resins comprising a mixture of α,α-branched alkane carboxylic glycidyl esters derived from butene oligomers characterized in that the sum of the concentration of the blocked and of the highly branched isomers is at least 50%, preferably above 60% and most preferably above 75% on total composition, which can lead for example to improved hardness of the coatings derived thereof.

More in particular the invention relates to polyether polyol resins compositions comprising of aliphatic tertiary saturated carboxylic acids or α,α-branched alkane carboxylic acids, which contain 9 or 13 carbon atoms and which provide glycidyl esters with a branching level of the alkyl groups depending on the olefin feedstock used and/or the oligomerization process thereof, and which is defined as below.

The glycidyl ester derived from propene or containing 5 carbon atoms in the alkyl chain are used by the industry to introduce modified resins by reaction such a glycidyl ester with polyols. U.S. Pat. No. 5,051,492 is about the process to prepare such a modified resins using metal salt to carry out the etherification reaction of a polyol and a 10 carbon chain alkyl glycidyl ester. The WO2007/041633 introduces the modification of C5 glycidyl ester, which as for effect to provide a coating composition with a low content of volatile organic compounds. The same technical approach was given in US 2007/0117938.

It is generally known from e.g. U.S. Pat. No. 2,831,877, U.S. Pat. No. 2,876,241, U.S. Pat. No. 3,053,869, U.S. Pat. No. 2,967,873 and U.S. Pat. No. 3,061,621 that mixtures of a,a-branched alkane carboxylic acids can be produced, starting from mono-olefins, such as butenes and isomers such as isobutene, carbon monoxide and water, in the presence of a strong acid.

The glycidyl esters can be obtained according to PCT/EP2010/003334 or the U.S. Pat. No. 6,433,217.

We have discovered that well chosen blend of isomers of the glycidyl ester of, for example, neononanoic acids give different and unexpected performance in combination with some particular polymers such as polyether polyols.

The isomers are described in Table 1 and illustrated in Scheme 1.

We have found that the performance of the glycidyl ester compositions derived from the branched acid is depending on the branching level of the alkyl groups R¹, R² and R³, for example the neononanoic acid has 3, 4 or 5 methyl groups. Highly branched isomers are defined as isomers of neo-acids having at least 5 methyl groups.

Neo-acids, for example neononanoic acids (V9) with a secondary or a tertiary carbon atoms in the β position are defined as blocking isomers.

Mixture compositions of neononanoic acids glycidyl esters providing for example a high hardness of a coating, is a mixture where the sum of the concentration of the blocked and of the highly branched isomers is at least 50%, preferably above 60% and most preferably above 75% on total composition.

The composition of the glycidyl ester mixture is comprising 2,2-dimethyl 3,3-dimethyl pentanoic acid glycidyl ester or 2-methyl 2-isopropyl 3-methyl butanoic acid glycidyl ester or 2-methyl 2-ethyl 3,3-dimethyl butanoic acid glycidyl ester.

The composition of the glycidyl ester mixture is comprising 2,2-dimethyl 3-methyl 4-methyl pentanoic acid glycidyl ester and 2,2-dimethyl 4,4-dimethyl pentanoic acid glycidyl ester.

The composition of the glycidyl ester mixture in which the sum of the following content of glycidyl ester mixture, comprising 2,2-dimethyl 3,3-dimethyl pentanoic acid glycidyl ester and 2-methyl 2-isopropyl 3-methyl butanoic acid glycidyl ester and 2-methyl 2-ethyl 3,3-dimethyl butanoic acid glycidyl ester, is above 10% weight, preferably above 15% weight and most preferably above 25% weight on total composition.

The composition of the glycidyl ester mixture in which the sum of the following content of glycidyl ester mixture, comprising 2,2-dimethyl 3,3-dimethyl pentanoic acid glycidyl ester and 2-methyl 2-isopropyl 3-methyl butanoic acid glycidyl ester and 2-methyl 2-ethyl 3,3-dimethyl butanoic acid glycidyl ester and 2,2-dimethyl 3-methyl 4-methyl pentanoic acid glycidyl ester and 2,2-dimethyl 4,4-dimethyl pentanoic acid glycidyl ester, is above 40% weight, preferably above 50% weight and most preferably above 60% weight on total composition.

The composition of the glycidyl ester mixture in which the content of 2-methyl 2-ethyl hexanoic acid glycidyl ester is below 40% weight, preferably below 30% weight and most preferably below 20% weight on total composition.

The composition of the glycidyl ester mixture in which the glycidyl ester mixture is comprising 2,2-dimethyl 3,3-dimethyl pentanoic acid glycidyl ester in 1 to 99 weight % or 2-methyl 2-isopropyl 3-methyl butanoic acid glycidyl ester in 1 to 99 weight % or 2-methyl 2-ethyl 3,3-dimethyl butanoic acid glycidyl ester in 1 to 99 weight % on total composition.

A preferred composition of the glycidyl ester mixture in which the glycidyl ester mixture is comprising 2,2-dimethyl 3,3-dimethyl pentanoic acid glycidyl ester in 2 to 50 weight % or 2-methyl 2-isopropyl 3-methyl butanoic acid glycidyl ester in 5 to 50 weight % or 2-methyl 2-ethyl 3,3-dimethyl butanoic acid glycidyl ester in 3 to 60 weight % on total composition.

A further preferred composition of the glycidyl ester mixture in which the glycidyl ester mixture is comprising 2,2-dimethyl 3,3-dimethyl pentanoic acid glycidyl ester in 3 to 40 weight % or 2-methyl 2-isopropyl 3-methyl butanoic acid glycidyl ester in 10 to 35 weight % or 2-methyl 2-ethyl 3,3-dimethyl butanoic acid glycidyl ester in 5 to 40 weight % on total composition.

The composition of the glycidyl ester mixture in which the glycidyl ester mixture is comprising 2,2-dimethyl 3-methyl 4-methyl pentanoic acid glycidyl ester in 1 to 99 weight % or 2,2-dimethyl 4,4-dimethyl pentanoic acid glycidyl ester in 0.1 to 99 weight %.

A preferred composition of the glycidyl ester mixture in which the glycidyl ester mixture is comprising 2,2-dimethyl 3-methyl 4-methyl pentanoic acid glycidyl ester in 2 to 50 weight % or 2,2-dimethyl 4,4-dimethyl pentanoic acid glycidyl ester in 0.1 to 80 weight %.

A further preferred composition of the glycidyl ester mixture in which the glycidyl ester mixture is comprising 2,2-dimethyl 3-methyl 4-methyl pentanoic acid glycidyl ester in 4 to 25 weight % or 2,2-dimethyl 4,4-dimethyl pentanoic acid glycidyl ester in 0.2 to 45 weight %.

The above glycidyl esters compositions can be used for example, as reactive diluent or as monomer in binder compositions for paints or adhesives.

The glycidyl esters compositions can be used as reactive diluent for epoxy based formulations such as exemplified in the technical brochure of Momentive (Product Bulletin: Cardura E10P The Unique Reactive Diluent MSC-512).

Other uses of the glycidyl ester are the combinations with polyester polyols, or acrylic polyols, or polyether polyols. The combination with polyether polyols such as could be used in the car industry coating leads to a fast drying coating system with attractive coating properties.

### Methods Used

The isomer distribution of neo-acid can be determined using gas chromatography, using a flame ionization detector (FID). 0.5 ml sample is diluted in analytical grade dichloromethane and n-octanol may be used as internal standard. The conditions presented below result in the approximate retention times given in Table 1. In that case n-octanol has a retention time of approximately 8.21 minute.

The GC method has the following settings:
Column: CP Wax 58 CB (FFAP), 50 m×0.25 mm, df=0.2 μm
Oven program: 150° C. (1.5 min)−3.5° C./min−250° C. (5 min)=35 min
Carrier gas: Helium
Flow: 2.0 mL/min constant
Split flow: 150 mL/min
Split ratio: 1:75
Injector temp: 250° C.
Detector temp: 325° C.
Injection volume: 1 μL

CP Wax 58 CB is a Gas chromatography column available from Agilent Technologies.

The isomers of neononanoic acid as illustrative example have the structure (R¹R²R³)—C—COOH where the three R groups are linear or branched alkyl groups having together a total of 7 carbon atoms.

The structures and the retention time, using the above method, of all theoretical possible neononanoic isomers are drawn in Scheme 1 and listed in Table 1.

The isomers content is calculated from the relative peak area of the chromatogram obtained assuming that the response factors of all isomers are the same.

TABLE 1
Structure of all possible neononanoic isomers

| | | | | | | Retention |
|---|---|---|---|---|---|---|
| | | | | Methyl | Block- | time |
| | R1 | R2 | R3 | groups | ing | [Minutes] |
| V901 | Methyl | Methyl | n-pentyl | 3 | No | 8.90 |
| V902 | Methyl | Methyl | 2-pentyl | 4 | Yes | 9.18 |
| V903 | Methyl | Methyl | 2-methyl | 4 | No | 8.6 |
| | | | butyl | | | |
| V904 | Methyl | Methyl | 3-methyl | 4 | No | 8.08 |
| | | | butyl | | | |
| V905 | Methyl | Methyl | 1,1-dimethyl | 5 | Yes | 10.21 |
| | | | propyl | | | |
| V906 | Methyl | Methyl | 1,2-dimethy | 5 | Yes | 9.57 |
| | | | propyl | | | |
| V907 | Methyl | Methyl | 2,2-dimethyl | 5 | No | 8.26 |
| | | | propyl | | | |
| V908 | Methyl | Methyl | 3-pentyl | 4 | Yes | 9.45 |
| V909 | Methyl | Ethyl | n-butyl | 3 | No | 9.28 |
| V910 | Methyl | Ethyl | s-butyl | 4 | Yes | 9.74 |
| K1 | | | | | | |
| V910 | Methyl | Ethyl | s-butyl | 4 | Yes | 9.84 |
| K2 | | | | | | |
| V911 | Methyl | Ethyl | i-butyl | 4 | No | 8.71 |
| V912 | Methyl | Ethyl | t-butyl | 5 | Yes | 9.64 |
| V913 | Methyl | n-propyl | n-propyl | 3 | No | 8.96 |
| V914 | Methyl | n-propyl | i-propyl | 4 | Yes | 9.30 |
| V915 | Methyl | i-propyl | i-propyl | 5 | Yes | 9.74 |
| V916 | Ethyl | Ethyl | n-propyl | 3 | No | 9.44 |
| V917 | Ethyl | Ethyl | i-propyl | 4 | Yes | 10.00 |

The isomer distribution of glycidyl esters of neo-acid can be determined by gas chromatography, using a flame ionization detector (FID). 0.5 ml sample is diluted in analytical grade dichloromethane.

The GC method has the following settings:
Column: CP Wax 58 CB (FFAP), 50 m×0.2 mm, df=0.52 μm
Oven: 175° C. (5 min)−1° C./min−190° C. (0 min)−10° C./min−275° C. (11.5 min)
Flow: 2.0 mL/min, constant flow
Carrier gas: Helium
Split ratio: 1:75
Injection volume: 1 μL
S/SL injector: 250° C.

CP Wax 58 CB is a Gas chromatography column available from Agilent Technologies.

The isomers of glycidyl esters of neononanoic acid as illustrative example have the structure (R¹R²R³)—C—COO—CH₂—CH(O)CH₂ where the three R groups are linear or branched alkyl groups having together a total of 7 carbon atoms.

The isomers content is calculated from the relative peak area of the chromatogram obtained assuming that the response factors of all isomers are the same.

GC-MS method can be used to identify the various isomers providing that the analysis is done by a skilled analytical expert.

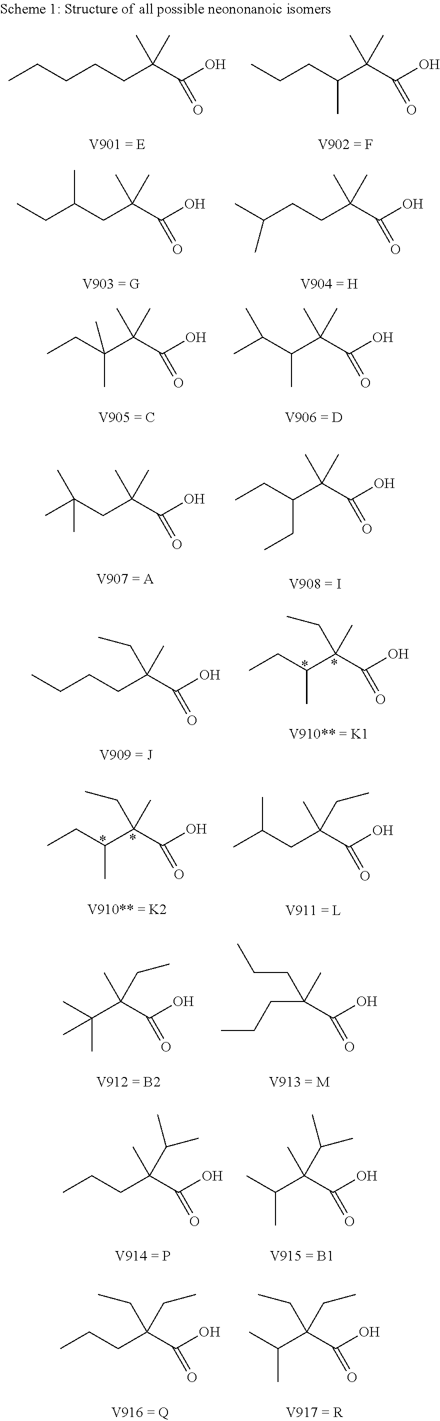

### Methods for the Characterization of the Resins

The molecular weights of the resins are measured with gel permeation chromatography (Perkin Elmer/Water) in THF solution using polystyrene standards. Viscosity of the resins are measured with Brookfield viscometer (LVDV-I) at indicated temperature. Solids content are calculated with a function (Ww−Wd)/Ww×100%. Here Ww is the weight of a wet sample, Wd is the weight of the sample after dried in an oven at a temperature 110° C. for 1 hour.

Tg (glass transition temperature) has been determined either with a DSC 7 from Perkin Elmer or with an apparatus from TA Instruments Thermal Analysis. Scan rates were respectively 20 and 10° C./min. Only data obtained in the same experimental conditions have been compared. If not, the temperature difference occurring from the different scanning rate has been proved not significant for the results compared.

### Blocking Isomers

Whereas the carbon atom in alpha position of the carboxylic acid is always a tertiary carbon atom, the carbon atom(s) in β position can either be primary, secondary or tertiary. Neononanoic acids (V9) with a secondary or a tertiary carbon atoms in the β position are defined as blocking (blocked) isomers (Schemes 2 and 3).

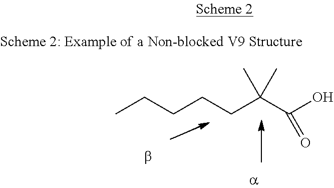

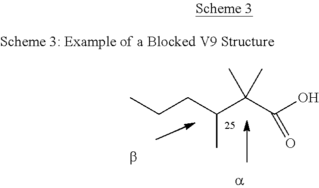

The use of the glycidyl esters compositions, discussed here above, can be as monomer in binder compositions for paints and adhesives. These binders can be based on a polyether polyol resin comprising the above composition glycidyl.

The polyether polyol resins of the invention are based on a composition of hydroxyl functional polyether resins (polyether polyols) comprising a mixture of α,α-branched alkane carboxylic glycidyl esters derived from butene oligomers characterized in that the sum of the concentration of the blocked and of the highly branched isomers is at least 50%, preferably above 60% and most preferably above 75% on total composition, which can lead for example to improved hardness of the coatings derived thereof.

A preferred composition is that the glycidyl ester mixture is based on neononanoic (C9) acid mixture where the sum of the concentration of the blocked and of the highly branched isomers is at least 50%, preferably above 60% and most preferably above 75% on total composition.

Further the neononanoic (C9) glycidyl ester mixture is comprising 2,2-dimethyl 3,3-dimethyl pentanoic acid glycidyl ester or 2-methyl 2-isopropyl 3-methyl butanoic acid glycidyl ester or 2-methyl 2-ethyl 3,3-dimethyl butanoic acid glycidyl ester.

Another embodiment is that the composition of the glycidyl ester mixture is comprising 2,2-dimethyl 3-methyl 4-methyl pentanoic acid glycidyl ester or 2,2-dimethyl 4,4-dimethyl pentanoic acid glycidyl ester.

A further embodiment is that the composition of the glycidyl ester mixture is comprising the sum of the following content of glycidyl ester mixture, comprising 2,2-dimethyl 3,3-dimethyl pentanoic acid glycidyl ester and 2-methyl 2-isopropyl 3-methyl butanoic acid glycidyl ester and 2-methyl 2-ethyl 3,3-dimethyl butanoic acid glycidyl ester, is above 10% weight, preferably above 15% weight and most preferably above 25% weight on total composition.

A further embodiment is that the composition of the glycidyl ester mixture is comprising the sum of the following content of glycidyl ester mixture, comprising 2,2-dimethyl 3,3-dimethyl pentanoic acid glycidyl ester and 2-methyl 2-isopropyl 3-methyl butanoic acid glycidyl ester and 2-methyl 2-ethyl 3,3-dimethyl butanoic acid glycidyl ester and 2,2-dimethyl 3-methyl 4-methyl pentanoic acid glycidyl ester and 2,2-dimethyl 4,4-dimethyl pentanoic acid glycidyl ester, is above 40% weight, preferably above 50% weight and most preferably above 60% weight on total composition.

A further embodiment is that the composition of the glycidyl ester mixture is comprising 2-methyl 2-ethyl hexanoic acid glycidyl ester is below 40% weight, preferably below 30% weight and most preferably below 20% weight on total composition.

A further embodiment is that the composition of the glycidyl ester mixture is comprising 2,2-dimethyl 3,3-dimethyl pentanoic acid glycidyl ester in 1 to 99 weight % or 2-methyl 2-isopropyl 3-methyl butanoic acid glycidyl ester in 1 to 99 weight % or 2-methyl 2-ethyl 3,3-dimethyl butanoic acid glycidyl ester in 1 to 99 weight % on total composition and a preference is in that the glycidyl ester mixture is comprising 2,2-dimethyl 3,3-dimethyl pentanoic acid glycidyl ester in 2 to 50 weight % or 2-methyl 2-isopropyl 3-methyl butanoic acid glycidyl ester in 5 to 50 weight % or 2-methyl 2-ethyl 3,3-dimethyl butanoic acid glycidyl ester in 3 to 60 weight % on total composition, and a most preferred composition is that the glycidyl ester mixture is comprising 2,2-dimethyl 3,3-dimethyl pentanoic acid glycidyl ester in 3 to 40 weight % or 2-methyl 2-isopropyl 3-methyl butanoic acid glycidyl ester in 10 to 35 weight % or 2-methyl 2-ethyl 3,3-dimethyl butanoic acid glycidyl ester in 5 to 40 weight % on total composition.

A further embodiment is that the composition of the glycidyl ester mixture is comprising 2,2-dimethyl 3-methyl 4-methyl pentanoic acid glycidyl ester in 1 to 99 weight % or 2,2-dimethyl 4,4-dimethyl pentanoic acid glycidyl ester in 0.1 to 99 weight %, a preferred composition is that the glycidyl ester mixture is comprising 2,2-dimethyl 3-methyl 4-methyl pentanoic acid glycidyl ester in 2 to 50 weight % or 2,2-dimethyl 4,4-dimethyl pentanoic acid glycidyl ester in 0.1 to 80 weight %, and a most preferred composition is that the glycidyl ester mixture is comprising 2,2-dimethyl 3-methyl 4-methyl pentanoic acid glycidyl ester in 4 to 25 weight % or 2,2-dimethyl 4,4-dimethyl pentanoic acid glycidyl ester in 0.2 to 45 weight %.

The process to prepare the compositions of the polyether polyol resin is by reaction of a polyol can be selected from for example: trimethylolpropane, ditrimethylolpropane, pentaerythritol, dipentaerythritol, tripentaerythritol, neopentyl glycol, glycerine, ethyleneglycol, cyclohexane dimethylol 1,4, mannitol, xylitol, isosorbide, erythritol, sorbitol, ethylene glycol, 1,2-propylene glycol, 1,2-butylene glycol, 2,3-butylene glycol, 1,2-hexanediol, 1,2-dihydroxycyclohexane, 3-ethoxypropane-1,2-diol and 3-phenoxypropane-1,2-diol; neopentyl glycol, 2-methyl-1,3-propanediol, 2-methyl-2,4-pentanediol, 3-methyl-1,3-butane diol, 2-ethyl-1,3-hexanediol, 2,2-diethyl-1,3-propanediol, 2,2,4-trimethyl-1,3-pentanediol, 2-butyl-2-ethyl-1,3-propanediol, 2-phenoxypropane-1,3-diol, 2-methyl-2-phenylpropane-1,3-diol, 1,3-propylene glycol, 1,3-butylene glycol, 2-ethyl-1,3-octanediol, 1,3-dihydroxycyclohexane, 1,4-butanediol, 1,4-dihydroxycyclohexane, 1,5-pentanediol, 1,6-hexanediol, 2,5-hexanediol, 3-methyl-1,5-pentanediol, 1,4-dimethylolcyclohexane, tricyclodecanedimethanol, 2,2-dimethyl-3-hydroxypropyl-2,2-dimethyl-3-hydroxypropyonate (an esterification product of hydroxy-pivalic acid with neopentyl glycol), 2,2,4-Trimethyl-1,3-pentanediol (TMPD), mixture of 1,3- and 1,4-cyclohexanedimethanol (=Unoxol diol ex Dow Chemicals), bisphenol A, bisphenol F, bis(4-hydroxyhexyl)-2,2-propane, bis(4-hydroxyhexyl)methane, 3,9-bis(1,1-dimethyl-2-hydroxyethyl)-2,4,8,10-tetroxaspiro[5,5]-undecane, di-ethylene glycol, triethylene glycol, glycerine, diglycerine, triglycerine, trimethylol-ethane and tris(2-hydroxyethyl)isocyanurate. Either pure multifunctional polyol can be used or mixtures of at least two of them, and the glycidyl ester mixture as define above.

The polyether polyol resins of the invention prepared according to the above processes will have a number average molecular weight (Mn) lower than 4500 Dalton according the polystyrene standard, and/or the hydroxyl value is above 120 mg KOH/g solids on solid.

The invention is also related to a binder composition useful for coating composition comprising at least any hydroxyl functional polyether resins as prepared above.

The said binder compositions are suitable for coating metal or plastic substrates.

### EXAMPLES

### Chemicals Used

Cardura™ E10: available from Momentive Specialty Chemicals
Neononanoic glycidyl ester from Momentive Specialty Chemicals
GE9S: neononanoic glycidyl ester of composition A (see Table 2)
GE9H: neononanoic glycidyl ester of composition B (see Table 2)
Neononanoic glycidyl ester of composition C (see Table 2)
Neononanoic glycidyl ester of composition D (see Table 2)
Neononanoic glycidyl ester of composition E (see Table 2)

TABLE 2
Composition of the neononanoic glycidyl ester
(according to the described gas chromatography
method for glycidyl esters of neo-acid)

| Glycidyl ester of acid V9XX | A | B | C | D | E |
|---|---|---|---|---|---|
| (described in Table 1) | (%) | (%) | (%) | (%) | (%) |
| V901 | 6.5 | 0.1 | 3.7 | 0.1 | 0.1 |
| V902 | 0.6 | 2.55 | 0.6 | 2.4 | 2.65 |
| V903 | 1.1 | 0.7 | 0.3 | 1.0 | 0.4 |
| V904 | 0.8 | 1 | 0.1 | 2.2 | 0.4 |
| V905 | 0.2 | 13.1 | 0.5 | 4.1 | 14.5 |
| V906 | 0.4 | 11.6 | 0.4 | 9.6 | 12.6 |
| V907 | 0.2 | 15.4 | 0.1 | 36.4 | 5.6 |
| V908 | 0.1 | 0 | 0.1 | 0.0 | 0.0 |
| V909 | 54.8 | 2.55 | 52.8 | 2.4 | 2.65 |
| V910 K1 | 7.8 | 0 | 10.0 | 0.0 | 0.0 |
| V910 K2 | 7.7 | 0.6 | 12.8 | 0.4 | 0.7 |
| V911 | 2.4 | 1.2 | 0.7 | 2.0 | 0.8 |
| V912 | 0.0 | 28.3 | 0.0 | 22.4 | 33.5 |
| V913 | 6.8 | 0.1 | 6.4 | 0.1 | 0.1 |
| V914 | 4.5 | 0 | 3.8 | 0.0 | 0.0 |
| V915 | 0.6 | 22.3 | 0.6 | 16.8 | 25.3 |
| V916 | 4.4 | 0.1 | 5.2 | 0.1 | 0.1 |
| V917 | 1.1 | 0.4 | 2.1 | 0.1 | 0.4 |

GES: glycidyl ester of pivalic acid obtained by reaction of the acid with epichlorhydrin.
Ethylene glycol from Aldrich
Monopentaerythritol: available from Sigma-Aldrich
3,3,5 Trimethyl cyclohexanol: available from Sigma-Aldrich
Maleic anhydride: available from Sigma-Aldrich
Methylhexahydrophtalic anhydride: available from Sigma-Aldrich
Hexahydrophtalic anhydride: available from Sigma-Aldrich
Boron trifluoride diethyl etherate (BF3.OEt2) from Aldrich
Acrylic acid: available from Sigma-Aldrich
Methacrylic acid: available from Sigma-Aldrich
Hydroxyethyl methacrylate: available from Sigma-Aldrich
Styrene: available from Sigma-Aldrich
2-Ethylhexyl acrylate: available from Sigma-Aldrich
Methyl methacrylate: available from Sigma-Aldrich
Butyl acrylate: available from Sigma-Aldrich
Di-t-Amyl Peroxide is Luperox DTA from Arkema
tert-Butyl peroxy-3,5,5-trimethylhexanoate: available from Akzo Nobel
Xylene
n-Butyl Acetate from Aldrich
Dichloromethane from Biosolve
Thinner: A: is a mixture of Xylene 50 wt %, Toluene 30 wt %, ShellsolA 10 wt %, 2-Ethoxyethylacetate 10 wt %. Thinner B: is butyl acetate
Curing agents, HDI: 1,6-hexamethylene diisocyanate trimer, Desmodur N3390 BA from Bayer Material Science or Tolonate HDT LV2 from Perstorp
Leveling agent: ‘BYK 10 wt %’ which is BYK-331 diluted at 10% in butyl acetate
Catalyst: ‘DBTDL 1 wt %’ which is Dibutyl Tin Dilaurate diluted at 1 wt % in butyl acetate
Catalyst: ‘DBTDL 10 wt %’ which is Dibutyl Tin Dilaurate diluted at 10 wt % in butyl acetate

### Example 01

The following constituents were charged to a reaction vessel: 2.5500 grams of a neononanoic glycidyl ester of composition D, 1.1571 grams of dichloromethane, 0.0137 grams of boron trifluoride diethyl etherate. The reaction took place for 3 days at room temperature and the solvent was then thoroughly removed by evaporation. The polyether had a molecular weight (Mw) of 1900 Daltons and a Tg of −40.5° C.

### Example 02 Comparative

The following constituents were charged to a reaction vessel: 2.5438 grams of a neononanoic glycidyl ester of composition C, 1.0150 grams of dichloromethane, 0.0128 grams of boron trifluoride diethyl etherate. The reaction took place for 3 days at room temperature and the solvent was then thoroughly removed by evaporation. The polyether had a molecular weight (Mw) of 1500 Daltons and a Tg of −51.1° C.

Observations: Tg of the modified polyether resin is impacted by the composition of the neononanoic glycidyl ester (see examples 01, 02).

### Example 03

Polyether Resin

The following constituents were charged to a reaction vessel equipped with a stirrer, a thermometer and a condenser: 134 grams of di-Trimethylol propane (DTMP), 900 grams of glycidyl neononanoate, GE9H, 135.5 grams of n-butylacetate (BAC) and 2.5 grams of Tin 2 Octoate. The mixture was heated to its reflux temperature of about 180° C. for about 4 hours till the glycidyl neononaoate was converted to an epoxy group content of less than 0.12 mg/g. After cooling down the polyether had a solids content of about 88%.

### Example 04 Comparative

Polyether Resin

The following constituents were charged to a reaction vessel equipped with a stirrer, a thermometer and a condenser: 28.8 grams of monopentaerythritol, 201.5 grams of Cardura E10P, 19.4 grams of n-butylacetate and 0.3552 grams of Tin (II) 2-ethylhexanoate. The mixture was heated to a temperature of about 180° C. for about 6 hours till the Cardura E10P was converted to an epoxy group content of about 25 mmol/kg. After cooling down the polyether had a solids content of about 94%.

### Example 05 Comparative

Polyether Resin

The following constituents were charged to a reaction vessel equipped with a stirrer, a thermometer and a condenser: 28.8 grams of monopentaerythritol, 187.1 grams of GE9S, 18.3 grams of n-butylacetate and 0.3550 grams of Tin (II) 2-ethylhexanoate. The mixture was heated to a temperature of about 180° C. for about 5.5 hours till the GE9S was converted to an epoxy group content of about 29 mmol/kg. After cooling down the polyether had a solids content of about 95%.

### Example 06

Polyether Resin

The following constituents were charged to a reaction vessel equipped with a stirrer, a thermometer and a condenser: 28.8 grams of monopentaerythritol, 189.4 grams of GE9H, 18.5 grams of n-butylacetate and 0.3572 grams of Tin (II) 2-ethylhexanoate. The mixture was heated to a temperature of about 180° C. for about 4 hours till the GE9H was converted to an epoxy group content of about 27 mmol/kg. After cooling down the polyether had a solids content of about 95%.

### Example 07 Comparative

Polyether Resin

The following constituents were charged to a reaction vessel equipped with a stirrer, a thermometer and a condenser: 29.0 grams of monopentaerythritol, 136.7 grams of GE5, 14.0 grams of n-butylacetate and 0.3597 grams of Tin (II) 2-ethylhexanoate. The mixture was heated to a temperature of about 180° C. for about 5.7 hours till the GE5 was converted to an epoxy group content of about 27 mmol/kg. After cooling down the polyether had a solids content of about 94%.

### Formulation of the Clear Coats

A clear coat is formulated with one of the polyether (from examples 04, 05, 06 or 07, the curing agent (HDI, Desmodur N3390), the thinner (Methyl Amyl Ketone), the leveling agent (BYK-331) and the catalyst (dibutyltin dilaurate, DBTDL) according to the amounts indicated in Table 3.

TABLE 3
Clear coats, formulations

| | | | | BYK 10 | DBTDL | |
|---|---|---|---|---|---|---|
| CEP- | Binder | Binder | HDI | wt % | 1 wt % | Thinner |
| Example | (ID) | (g) | (g) | (g) | (g) | (g) |
| CEP-04 | From | 40.1 | 30.7 | 0.47 | 1.03 | 15.1 |
| | Example 04 | | | | | |
| CEP-05 | From | 40.0 | 33.0 | 0.48 | 1.07 | >12.5 |
| | Example 05 | | | | | |
| CEP-06 | From | 40.0 | 32.5 | 0.48 | 1.06 | 17.7 |
| | Example 06 | | | | | |
| CEP-07 | From | 40.1 | 42.9 | 0.54 | 1.20 | 17.7 |
| | Example 07 | | | | | |

### Characterization of the Clear Coats

The clearcoat formulations (from Table 3) are applied with a barcoater on degreased Q-panel, optionally on basecoated Q-panel. The panels are dried at room temperature after a preliminary stoving at 60° C. for 30 min. Clear coats have been characterized among others by measuring the Koenig hardness development (see Table 4).

TABLE 4
Clear coats, drying (curing) properties

| | | | |
|---|---|---|---|
| CEP-04 | CEP-05 | CEP-06 | CEP-07 |

1°/Koenig Hardness (Degreased Q panels) (sec)

| | | | | | |
|---|---|---|---|---|---|
| 6 | hours | 8 | 10 | 11 | 10 |
| 24 | hours | 10 | 11 | 47 | 42 |
| 7 | days | 18 | 20 | 94 | 122 |

2°/Koenig Hardness (Basecoated Q panels) (sec)

| | | | | | |
|---|---|---|---|---|---|
| 6 | hours | 7 | 8 | 7 | 8 |
| 24 | hours | 8 | 8 | 14 | 17 |
| 7 | days | 12 | 13 | 34 | 48 |

Observation (see Table 4): significant improvement (quicker hardness development) is observed when replacing Cardura E10P or GE9S by GE9H for the polyether cooking. Early hardness improvement on degreased Q-panels is better for example CEP-06 than for example CEP-07.

### Example 08

Polyester-Ether Resin

The following constituents were charged to a reaction vessel equipped with a stirrer, a thermometer and a condenser: 456 g of GE9H, 134 g of dimethylolpropionic acid and 0.35 g of stannous octoate.

The mixture was heated to a temperature of about 110° C. for about 1 hour and then steadily increased to 150° C. in 3 hours and then cooled down. After cooling down the polyester-ether had an epoxy group content of 4 mmol/kg, a solids content of about 99% a viscosity of 254000 cP an acid value of 1.3 mg KOH/g and a theoretical OH content of 285 mg KOH/g.

This polyester-ether was then formulated in high solids and very high solids 2K polyurethane topcoats either as sole binder or as reactive diluent for an acrylic polyol.

1. A of polyether polyol resin composition comprising a mixture of α,α-branched alkane carboxylic glycidyl esters wherein a sum of the concentration of blocked and of highly branched isomers is at least 50 wt % based on the weight of the mixture.

2. The composition of claim 1 wherein the mixture of α,α-branched alkane carboxylic glycidyl esters is based on a neononanoic (C9) acid mixture wherein the sum of the concentration of the blocked and of the highly branched isomers is at least 50 wt % based on the weight of the mixture.

3. The composition of claim 2 wherein the mixture of α,α-branched alkane carboxylic glycidyl esters comprises 2,2-dimethyl 3,3-dimethyl pentanoic acid glycidyl ester, 2-methyl 2-isopropyl 3-methyl butanoic acid glycidyl ester or 2-methyl 2-ethyl 3,3-dimethyl butanoic acid glycidyl ester.

4. The composition of claim 3 wherein the mixture of α,α-branched alkane carboxylic glycidyl esters comprises 2,2-dimethyl 3-methyl 4-methyl pentanoic acid glycidyl ester or 2,2-dimethyl 4,4-dimethyl pentanoic acid glycidyl ester.

5. The composition of claim 3 wherein the mixture of α,α-branched alkane carboxylic glycidyl esters comprises 2,2-dimethyl 3,3-dimethyl pentanoic acid glycidyl ester, 2 methyl 2-isopropyl 3-methyl butanoic acid glycidyl ester and 2-methyl 2-ethyl 3,3-dimethyl butanoic acid glycidyl ester in an amount above 10 wt % based on the weight of the mixture.

6. The composition of claim 4 wherein the mixture of α,α-branched alkanecarboxylic glycidyl esters comprises 2,2-dimethyl 3,3-dimethyl pentanoic acid glycidyl ester, 2-methyl 2-isopropyl 3-methyl butanoic acid glycidyl ester, 2-methyl 2-ethyl 3,3-dimethyl butanoic acid glycidyl ester, 2,2-dimethyl 3-methyl 4-methyl pentanoic acid glycidyl ester and 2,2-dimethyl 4,4-dimethyl pentanoic acid glycidyl ester in an amount above 40 wt % based on the weight of the mixture.

7. The composition of claim 3 wherein the wherein the mixture of α,α-branched alkane carboxylic glycidyl esters comprises 2-methyl 2-ethyl hexanoic acid glycidyl ester in an amount below 40 wt % based on the weight of the mixture.

8. A process to prepare the polyether polyol resin composition of claim 1 comprising reacting of at least one polyol having at least three hydroxyl groups and the mixture of the α,α-branched alkane carboxylic glycidyl esters.

9. The process of claim 8 wherein the polyether polyol resin composition has a number average molecular weight (Mn) lower than 4500 Dalton according the polystyrene standard, or a hydroxyl value above 120 mg KOH/g on solids.

10. A binder composition useful for a coating application with a low VOC and comprising the polyether polyol resin composition of claim 1.

11. A metal or plastic substrate coated with a coating composition comprising the binder of claim 10.

12. A polyester-ether resin characterized in that it is the reaction product of the polyether polyol resin composition of claim 1 and dimethylol propionic acid.

13. The composition of claim 1 wherein the sum of the concentration of the blocked isomers and of the highly branched isomers is above 60 wt % based on the total weight of the mixture.

14. The composition of claim 1 wherein the sum of the concentration of the blocked isomers and of the highly branched isomers is above 75 wt % based on the weight of the mixture.

15. The composition of claim 2 wherein the sum of the concentration of the blocked isomers and of the highly branched isomers is above 60 wt % based on the total weight of the mixture.

16. The composition of claim 2 wherein the sum of the concentration of the blocked isomers and of the highly branched isomers is above 75 wt % based on the total weight of the mixture.

17. The composition of claim 5 wherein the mixture of α,α-branched alkane carboxylic glycidyl esters comprises 2,2-dimethyl 3,3-dimethyl pentanoic acid glycidyl ester, 2-methyl 2-isopropyl 3-methyl butanoic acid glycidyl ester and 2-methyl 2-ethyl 3,3-dimethyl butanoic acid glycidyl ester in an amount above 15 wt % based on the weight of the mixture.

18. The composition of claim 5 wherein the mixture of α,α-branched alkane carboxylic glycidyl esters comprises 2,2-dimethyl 3,3-dimethyl pentanoic acid glycidyl ester, 2-methyl 2-isopropyl 3-methyl butanoic acid glycidyl ester and 2-methyl 2-ethyl 3,3-dimethyl butanoic acid glycidyl ester in an amount above 25 wt % based on the weight of the mixture.

19. The composition of claim 6 wherein the mixture of α,α-branched alkane carboxylic glycidyl esters comprises 2,2-dimethyl 3,3-dimethyl pentanoic acid glycidyl ester, 2-methyl 2-isopropyl 3-methyl butanoic acid glycidyl ester, 2-methyl 2-ethyl 3,3-dimethyl butanoic acid glycidyl ester, 2,2-dimethyl 3-methyl 4-methyl pentanoic acid glycidyl ester and 2,2-dimethyl 4,4-dimethyl pentanoic acid glycidyl ester in an amount above 50 wt % based on the weight of the mixture.

20. The composition of claim 6 wherein the mixture of α,α-branched alkane carboxylic glycidyl esters comprises 2,2-dimethyl 3,3-dimethyl pentanoic acid glycidyl ester, 2-methyl 2-isopropyl 3-methyl butanoic acid glycidyl ester, 2-methyl 2-ethyl 3,3-dimethyl butanoic acid glycidyl ester, 2,2-dimethyl 3-methyl 4-methyl pentanoic acid glycidyl ester and 2,2-dimethyl 4,4-dimethyl pentanoic acid glycidyl ester in an amount above 60 wt % based on the weight of the mixture.

21. The composition of claim 7 wherein the mixture of a,a-branched alkane carboxylic glycidyl esters comprises 2-methyl 2-ethyl hexanoic acid glycidyl ester in an amount below 30 wt % based on the weight of the mixture.

23. The composition of claim 7 wherein the mixture of α,α-branched alkane carboxylic glycidyl esters comprises 2-methyl 2-ethyl hexanoic acid glycidyl ester in an amount below 20 wt % based on the weight of the mixture.

24. The composition of claim 1 wherein the mixture of α,α-branched alkane carboxylic glycidyl esters is derived from butene oligomers.
